(19) United States
(12) Patent Application Publication
(10) Pub. No.: US 2002/0038276 A1
(43) Pub. Date: Mar. 28, 2002

(54) Securities trade state tracking method and apparatus

(76) Inventors: Philippe Buhannic, New York, NY (US); Joseph Ahearn, New York, NY (US)

Correspondence Address: NIXON PEABODY, LLP, 8180 GREENSBORO DRIVE, SUITE 800, MCLEAN, VA, 22102, US

(21) Appl. No.: 09/891,217

(22) Filed: Jun. 26, 2001

Related U.S. Application Data
(60) Provisional application No. 60/214,256, filed on Jun. 26, 2000.
(60) Provisional application No. 60/298,083, filed on Jun. 15, 2001.

(51) Int. Cl. G06F 17/60

(52) U.S. Cl. 705/37

(57) ABSTRACT

A system for tracking the status of a securities trade. A computer system serves as a node and communicates with at least one buy side computer associated with a party desiring to purchase securities and at least one sell side computer associated with a party desiring to sell securities. A communications channel couples the node with the buy side computer and the sell side computer. The node includes a message broker server and a database. The message broker server monitors messages transmitted by the buy side computer and the sell side computer, determines a present state of a trade based on the content of the messages, and stores the present state in the database.

### RELATED APPLICATION DATA

This application claims benefit of provisional patent applications Ser. No. 60/214,256 filed on Jun. 26, 2000 and Ser. No. 60/298,083 filed on Jun. 15, 2001, the disclosures of which are hereby incorporated herein by reference.

### BACKGROUND

The invention relates generally to automated trading of securities and other financial products, and more particularly, to a method and apparatus for tracking the status of a securities trade on a real time basis.

The global financial marketplace represents the single largest purchasing market in the world. Historically, trading was conducted by placing a telephone call to a “broker” who would in turn place an order with a national or regional exchange in the case of listed products, or, in the cae of nonlisted or “over the counter” (OTC) products, with a firm that makes the market in such products. When an order was placed at an exchange, “traders” on the trading floor of the exchange effected the trade and the trades were confirmed by some form of notation or writing on paper. Once effected, the trades or transfers of the securities were formally reported back to the brokers for the purchasing and selling customers in a formal way.

More recently, securities transactions have become automated so that trades may be accomplished by a trader operating a keyboard to enter the necessary commands into a terminal or client computer coupled to a server of the applicable exchange. With an automated system a trader may enter an order to buy or sell which is transmitted to the central system of the applicable exchange where it is matched with another trader who is willing to sell or buy the same securities, and the computer then confirms the completion of the transaction to each trader, and the transaction is confirmed and recorded by means of a hard copy generated on a printer. Still, the trader must confirm the trade to the brokers. This may be accomplished in any manner.

In recent years, the equity markets have moved to adopt electronic trading on a global scale at a much more accelerated pace than have the other financial markets through the advent of Internet-based electronic trading systems (e.g., electronic retail brokerages) and standardization of communications protocols. While this revolution in the automation of the equity market has yielded significant advances in trading efficiency and liquidity through the opening of The NASDAQ Stock Market to new participants and the emergence of Electronic Communication Networks (ECNs) and Automated Trading Systems (ATSs), the influx of these new market participants and trading systems has also had the side-effect of increasing fragmentation of the equity market.

Known electronic trading systems come in several forms. “Single dealer systems” allow customers to execute trades through a single market-maker which provides exclusive access to listed exchanges or price quotes for the products covered. These systems typically provide access to only a narrow range of products through a single liquidity source. “Multi-dealer systems” allow customers to execute trades through a centralized system with a number of market-makers to provide liquidity options primarily for a discrete number of OTC products. These systems also cover a limited range of products and require the use of other platforms to trade additional OTC and listed products. “Inter-dealer systems” enable broker-dealers to execute trades directly with other broker-dealers in those specific product segments covered by the systems. These systems were the first to provide an automated trading alternative to the traditional broker-to-broker relationship which depends on the assistance of intermediary firms to match bids and execute trades. Inter-dealer systems are not open to the buy-side customer and each system is only able to offer trading access to the particular products covered by the system's sponsors.

On the other hand, “information providers” possess some current form of transaction processing capability through their existing private networks and proprietary customer terminals. While these networks may be adaptable to offering a more integrated, multi-product, automated trading alternative, they are hampered by their reliance on non-Internet-based technology, which necessitates more cumbersome connectivity for customers. “Independent System Vendors” are primarily software providers developing a product or system to provide connectivity to established sources of liquidity in the form of electronic linkages to select exchanges and ECNs)

There are several primary reasons why electronic trading systems have not been universally adopted outside of the retail equity market. First, the fixed income market is very diverse and probably the most fragmented of all financial markets, with many smaller niche markets differentiated by type of product, market (e.g., OTC vs. listed), customer base and geographic region, making it more difficult to route and match trades among like-minded investors. Also, for many classes of products, there is no centralized market mechanism (e.g., Central Order Book) where the buy and sell side parties can meet directly. Instead, trade orders still must be channeled through a discrete number of market-makers that have at their disposal a considerable informational advantage. These market-makers often are able to use the information to control trading margins and transaction costs. As a result, these market-maker firms have limited incentive to disintermediate themselves from the process and develop more efficient, automated means of distribution. Further, the average size of trades is very high, effectively prohibiting participation by smaller players, resulting in fewer market participants (most of which are institutions) and, consequently, fewer sources of liquidity. Finally, there is a lack of standardized communications protocols and “Straight Through Processing” capabilities to facilitate transfer of information, ease of use and reduce transaction costs. Finally, the electronic trading solutions noted above merely replicate, in an electronic form, some specific pieces of the communications link between the various parities to a trade, either on the buy side or the sell side, but do not integrate the trading process.

A financial transaction, such as a securities trade, can be defined as a set of events taking the transaction from inquiry through acceptance by both parties down to the exchange of securities and cash. Conventional systems are disparate and thus trade state information was limited to reports culled from various systems and compiled in a batch form. Since the systems are disparate and numerous, (for example broker systems, exchange systems, and investor systems), transaction follow-up was cumbersome, prone to errors, and greatly delayed in time. Because a typical trade of securities is actually a series of events happening over time and between various parties, the trade process is highly complex. Further, since known systems do not integrate the entirety of the trading process, these systems cannot provide real time information relating to the status of a trade throughout all phases of the trading process.

### SUMMARY OF THE INVENTION

An object of the invention is to improve tracking of information relating to securities transactions. To achieve this and other objects, an aspect of the invention is a computer architecture for tracking the status of an equities trade comprising a node, at least one buy side computer associated with a party desiring to purchase equities and capable of transmitting messages related to a trade, at least one sell side computer associated with a party desiring to sell securities and capable of transmitting messages related to a trade, and a communication channel coupling the node with the buy side computer and the sell side computer. The node includes a message broker server and a database. The message broker server monitors messages transmitted by the buy side computer the said sell side computer and determines a present state of a trade based on the content of the messages. The present state is stored in the database.

### BRIEF DESCRIPTION OF THE DRAWING

The invention is described through a preferred embodiment and the attached drawing in which:

FIG. 1 is a schematic illustration of a trade state processing system of the preferred embodiment.

### DETAILED DESCRIPTION

Large buy-side institutional investors increasingly are demanding increased efficiencies similar to the automated retail equity market in terms of market access and liquidity, simplified clearing and settlement capability, and more direct, transparent access to information to facilitate the trading process. Specifically, these investors seek a “customer-oriented,” as opposed to “product- or dealer-oriented,” system. Applicant has identified capabilities that would increase market access and liquidity and provide better access to information in the trading process for such institutional investors and other parties. By extending the concept of Straight Through Processing to the entirety of the trading process, the entire trading process can be tracked (from pre-trade conception and research, to trade execution, to clearing and settlement, to post-trade analysis) in real-time and in a secure manner, without the need for time-consuming and inefficient manual intervention.

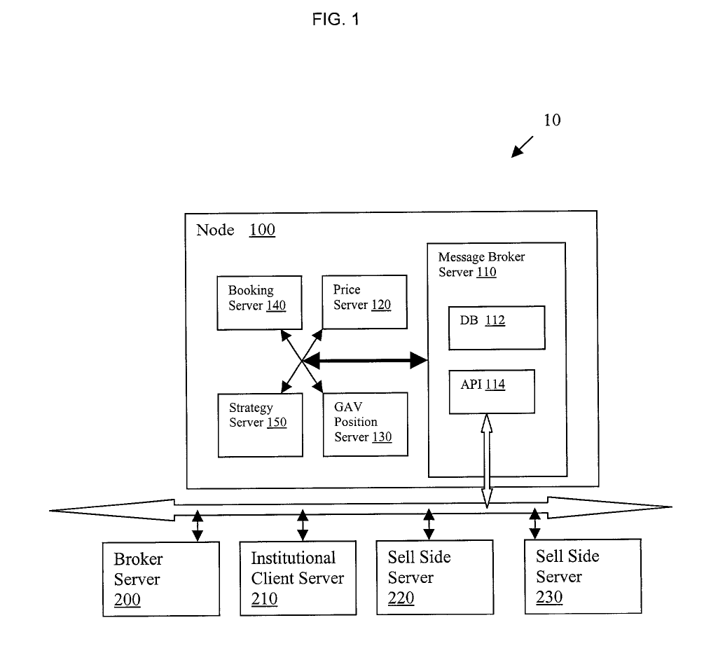

FIG. 1 is a block diagram of a trade state processing system in accordance with a preferred embodiment of the invention. System 10 includes node 100, as described in detail below. There may be a plurality of similar nodes in a clustered arrangement, redundant mirror arrangement, or coupled in any manner to provide scalability and/or fail-safe operation. Node 100 includes message broker server 110 which is Java Message Service (JMS) compliant and capable of transmitting and receiving messages in an eXtensible Markup Language (XML). Mapping can be used to interface node 100 with devices providing any type of messaging. Further, message broker server 110 is capable of interacting with other servers in system 10 to keep track of trade status, as described below.

Node 100 also includes product and price server 120 for obtaining and storing prices and market depth, in real time, for a plurality of products. Such products can include foreign and U.S. equities, foreign equities, equities options, futures, foreign exchange, government bonds, money markets, corporate and Euro bonds, swaps, repos, commodities and esoteric OTC products. Strategy server 150 stores trading strategy profiles for various buy side clients, such as individual investors or institutional investors, and includes the appropriate logic to initiate execution of a trade for a buy side client when the conditions or limits in the client's strategy profile are satisfied or met. Gross Asset Value (GAV) position server 130 for aggregating the portfolios of investors, including securities and cash, and for providing the each portfolio's gross asset value on a real time basis. Booking server 140 effects all transactions upon notice from strategy server 150 or a message received through message broker server 110. Message broker server 110 includes database 112 for retaining status data relating to each transaction effected through node 100 and any other nodes in system 100. API (application programming interface) module 114 of message broker server 110 provides an interface between node 100 and external devices to permit external devices to update and query database 112.

Node 100 is coupled to broker server 220, institutional investor server 210, and sell side servers 230 and 240. Broker server 220 is associated with securities broker, i.e., a firm or person engaged in executing orders to buy or sell securities for customers. Institutional investor server 210 is associated with an institutional investor, i.e., a firm or person engaged in managing and investing securities for others through a vehicle such as a mutual fund, retirement plan, or the like. Sell side servers 230 and 240 are associated with an exchange, such as a stock exchange, futures exchange, or the like. Each server respectively automates the processes of the associated entity and includes status information for transactions within the respective entity. For example, each server can be a conventional ECN or ATS. Further, each server is coupled to the node through a communication channel, such as the Internet, a LAN or a WAN, and the requisite cabling, wireless links, or the like.

Message broker server 110 tracks messages between the various servers of node 100 and the various external servers and other devices to coordinate trading of securities. The messages can be XML-based. In particular, when a trade request message is received from any one of broker server 200, institutional client server 110, sell side server 220, and sell side server 230, a state model, i.e., a dynamic record of the request, is created in database 12 and a proper state is assigned to the record. For example, the initial state may be “registered.” As an example, the trade state may be correlated to a transaction number or other indicator in the record by an XML element and child element as set forth below.

<Transaction_no>12345</Transaction_no>

<state>Registered </state>

Upon receipt of each subsequent message relating to a trade, message broker server 110 evaluates the new status of the trade based on the content of the message received, and updates the trade state by inserting the proper state between the “state” tags in the XML child element shown above. Of course, the record can be stored in any format. However, XML provides flexibility of messaging because it is HTTP compliant, human readable, and machine readable. All messaging passes through message broker server 110 and is evaluated thereby so that the record can be constantly updated with the status of each trade between the various parties at any time.

Message broker server 110 can be configured to use any indication of trade status. As an example, the following list of trade states and the meanings thereof can be used by message broker 110:

| | |
|---|---|
| Registered | Trades are on blotter to be executed |
| Quote Requested | Buy/Sell quote is requested via price server 120 (OTC |
| | Trades) |
| Quoted | Quote Received |
| Credit Pending | Credit check not vet received |
| Credit Approved | Credit approved for the order |
| Sent Pending | Listed order to be sent for execution |
| Sent | Listed order sent for execution |
| Ammended | A request for change in price or quantity has been |
| Pending | made |
| Amended | Requested change has been made to order |
| Cancel Pending | A request to cancel order has been made |
| Cancelled | Order has been canceled |
| Partially Executed | Order Agreement has been reached between parties |
| Executed | Parties have closed on order |
| Booked Pending | A back office or clearinghouse server has not yet |
| | recorded trade |
| Booked | Trade has been recorded in back office or clearing- |
| | house server |
| Allocation | Order is to be allocated into plural accounts |
| Pending | |
| Allocated | Order has been allocated into plural accounts |
| Clearing Pending | Exchange of futures for money is pending |
| Cleared | Futures have been exchanged for money |
| Settled Pending | Exchange of money for securities is pending |
| Settled | Securities have been exchanged for money |
| Failed | Trade could not be matched to counterpart record in |
| | clearinghouse |

It can be seen that the states listed above include pre-trade states, such as initial registration of interest in a trade, all the way though back-office clearing/settlement states. The use of message broker server 110 and centralized database 112 permits tracking of trade status throughout all phases of the trade process and amongst disparate systems front-end and back-office systems.

In order to efficiently determine and record the status of a trade, the preferred embodiment segregates the global financial marketplace into four primary product trading structures each having a different set of trade states. The structures are differentiated by the degree of negotiation required to effect trades in the products included within each structure and are delineated based on level of standardization of the products covered, the number and types of liquidity providers available for the products, and the environment in which the trade is transacted (e.g., exchange, ECN, ATS or market-maker).

The first trading structure includes “listed products.” These are standardized products (e.g., equity products and certain derivatives) with wide recognition that are traded on regulated exchanges or ECNs open to all investors and broker-dealers with full transparency for pricing. For these types of products, node 100 may connect to a number of global exchanges and ECNs, such as those associated with sell side server 220 and sell side server 230, to obtain prices, market depth and other information relating to trading capability for distribution to brokers or institutional clients.

The second structure includes “fast moving inventory,” such as foreign exchange and government bonds, that have become highly standardized, yet are not considered “listed” products as they are not traded on a regulated exchange or marketplace. Such products typically trade on electronic inter-dealer and multi-dealer systems and other ATSs that are generally not open to institutional investors. For these types of products, node 100 will connect to a number of global ATSs and OTC market-making desks, as sell side servers 220 and 230, to allow customers to trade instantaneously up to a threshold amount in a totally automated manner. Above the threshold, pricing may revert to manual control and a market-maker must provide quotes for the particular product.

The third structure includes “slow-moving inventory.” These products, e.g., corporate debt, commercial paper, emerging market debt, asset-backed securities, are less standardized and require a more complex negotiation process for orders to be matched. For these products, node 100 will connect to a number of OTC market-making desks, as sell side servers 220 and 230, to display to customers the inventory of products the connected market-maker is maintaining, allowing customers to trade directly off these prices for specified volume levels. All other prices can be quoted on demand through a “give and take” negotiation process with the market-maker. An automated credit module can be used to improve the negotiation process for trading in these products.

The fourth structure includes “esoteric products.” For these products, e.g. , customized financial instruments and commodities, there is no established listed or OTC market to execute trades. An auction facility can be used for these types of custom-made products (which may be derived from existing products traded through the system or may represent totally new product types).

The trade status and other information can be brought into an external system through API module 114 or viewed through an external GUI (graphical user interface), such as a web browser interface. Known security parameters and methods can be used to allow each party to access only the desired information.

The various servers and modules are broken down in the preferred embodiment by specific functions for the purpose of explaining the invention. However, these elements can be segregated and/or combined. For example, API module 114 and database 112 can be associated with plural servers or nodes. Further, the various server functions can be combined in a single device or multiple devices and can be embodied in hardware and/or software. Accordingly, the term “server” as used herein does not refer to a specific or distinct piece of hardware and may include one or more computers or other devices, or may be embodied in software residing in a single computer or device. Any type of communication channels can be used for transmitting the various messages. For example, the messages can be transmitted over the Internet using a secured sockets layer (SSL) or a private leased line. The messages and records can be in any format. Any party to a trade, or other party requiring information with respect to a trade, can be coupled to the trade state system. The invention can be applied to any type of securities trade and can track the trade through any state related to the trade.

The invention has been described through a preferred embodiment. However, various modifications can be made without departing from the scope of the invention as defined by the appended claims and legal equivalents.

What is claimed:

1. A computer architecture for tracking the status of a securities trade, said architecture comprising:
a node including;
at least one buy side computer associated with a party desiring to purchase securities and capable of transmitting messages related to a trade;
at least one sell side computer associated with a party desiring to sell securities and capable of transmitting messages related to a trade; and
a communication channel coupling said node with said buy side computer and said sell side computer;
wherein said node includes a message broker server and a database, said message broker server being operative to monitor messages transmitted by said buy side computer and said sell side computer and to determine a present state of a trade based on the content of the messages and to store the present state in said database.

2. An architecture as recited in claim 1, wherein the state of a particular trade stored in said database is updated in response to each transmission of a message related to the particular trade.

3. An architecture as recited in claim 1, wherein said at least one buy side computer comprises a server associated with a securities broker.

4. An architecture as recited in claim 1, wherein said at least one buy side computer comprises a server associated with an institutional investor.

5. An architecture as recited in claim 1, wherein said at least one sell side computer comprises a server associated with an exchange.
